(19) United States
(12) Patent Application Publication
(10) Pub. No.: US 2006/0134444 A1
(43) Pub. Date: Jun. 22, 2006

(54) Polyester resin and laminate paper using the same

(75) Inventors: Shintarou Kishimoto, Hiratsuka-Shi (JP); Michio Nakata, Hiratsuka-Shi (JP)

Correspondence Address: BIRCH STEWART KOLASCH & BIRCH, PO BOX 747, FALLS CHURCH, VA, 22040-0747, US

(73) Assignee: Mitsubishi Engineering-plastics Corporation, Tokyo (JP)

(21) Appl. No.: 11/220,679

(22) Filed: Sep. 8, 2005

(30) Foreign Application Priority Data
Sep. 8, 2004 (JP) 260446/2004
Sep. 17, 2004 (JP) 271299/2004
Jul. 6, 2005 (JP) 197272/2005
Jul. 6, 2005 (JP) 197456/2005

(51) Int. Cl. B32B 27/10

(52) U.S. Cl. 428/481; 528/272

(57) ABSTRACT

A polyester laminate paper with excellent adhesiveness, thermal resistance, moldability and the like as prepared by laminating a polyester resin in a pellet form on at least one of the faces of a paper, the polyester resin containing a butylene terephthalate recurring unit as the main component and satisfying the following conditions (1) and (2): (1) the melt tension thereof at 250° C. is 0.5 to 2.5 mN; and (2) the difference (ΔIV) between the intrinsic viscosity of pellet surface part IV (S) and the intrinsic viscosity of pellet center part IV (C) is 0.1 or less.

### BACKGROUND OF THE INVENTION

1. Field of the Invention

The present invention relates to a polyester resin containing a butylene terephthalate unit as the main recurring unit and having specific physico-chemical properties, and a laminate paper prepared by extruding the polyester resin on the surface of a paper. More specifically, the invention relates to a polyester resin with great extrusion properties, good container processability, great color and high releasability and additionally with good adhesion properties between paper and polyester film, as well as a paper laminated with the polyester resin (sometimes abbreviated as polyester laminate paper hereinbelow) with such great properties and a method for producing the laminate paper, and a paper container prepared by using the laminate paper.

2. Description of the Related Art

Food products for cooking under heating in microwave oven and simple oven have widely spread in recent years. One of the containers therefor is a container laminated with a thin film of a synthetic resin on paper (abbreviated as laminate paper container hereinafter). Compared with plastic containers, the laminate paper container has advantages of light weight, low production cost and high thermal resistance. Such laminate paper container has an additional advantage such that contaminants in the food products therein can be detected and tested with metal detectors. Such laminate paper container is used as lunch containers, side dish cups, frozen food trays and the like on sale at stations, convenience stores, and grocery stores, other than containers for cooking under heating including containers for preparing cakes and baked confectioneries.

Synthetic resin for use in the laminate paper container includes for example polymethylpentene resin, polyolefin-series resins, and polyester-series resins. Among them, polyester-series resins are the most excellent in terms of preventing the transfer of plastic odor and paper odor to food products therein and the modification of the taste of foods therein. Furthermore, polyester-series resins have great thermal resistance and high processability in good balance of their properties. Thus, polyester-series resins are used in various fields of food products.

U.S. Pat. No. 4,391,833 discloses an example of the use of a thermally resistant paperboard product prepared by attaching a water-impermeable layer on a first face of the base material of the paperboard and then attaching a water-permeable layer on a second face thereof as containers for food products, where polybutylene terephthalate (sometimes referred to as PBT hereinafter) is used as the binder of the water-impermeable layer. Additionally, the USP discloses that components constituting foods never permeate through the containers or never foam or explode under heating and can retain the brightness. However, the reference never describes anything about the method for producing the PBT or about the physico-chemical properties of the PBT or never suggests that the selection of a specific PBT resin with specific physico-chemical properties enables the production of a laminate paper with all of great extrusion properties, container processability, color, and PBT adhesion to paper.

JP-A-55-166247 discloses a food packaging container comprising a paper laminated with polyesters including PBT and particularly discloses that the heat seal properties can be improved by retaining the ratio of the intrinsic viscosity of the resin prior to and after extrusion to a specific value. However, it is polyethylene terephthalate (sometimes referred to as PET hereinafter) alone that the reference specifically discloses in the Examples. The reference never suggests that a laminate paper with all of great extrusion properties, container processability, color and PBT adhesion to paper can be obtained by selecting a specific PBT resin with specific physico-chemical properties.

JP-A-64-70620 discloses a paper container for heating in microwave oven as prepared by extruding and laminating PBT and that compared with containers prepared from PET resins, the container prepared from the PBT resin has greater thermal resistance, resistance against food contamination and food deposition along with higher oxygen permeability and heat seal properties. The reference includes descriptions about the essential use of a paper pretreated by corona discharge so as to improve the adhesion of the PBT resin to paper. However, the production cost thereof is disadvantageously high because simple lamination of the PBT resin onto the paper cannot give sufficient adhesiveness. Additionally, the reference never includes any description about the selection of a specific PBT resin with specific physico-chemical properties, which enables the production of a laminate paper with all of great extrusion properties, container processability, color, and PBT adhesion to paper. The reference describes in the Examples the use of PBT with an intrinsic viscosity of 1.26 (the value obtained by measurement in o-chlorophenol at 25° C.; the value corresponds to about 1.39 when measured in a mixture solvent of phenol/1,1,2,2-tetrachloroethane at a weight ratio of 1/1 at 30° C.). So as to get PBT with an intrinsic viscosity at about that level, generally, a solid phase polymerization process under more or less strict conditions is commonly employed. Therefore, it is understood that PBT with an intrinsic viscosity difference Δ as defined in accordance with the invention (difference in intrinsic viscosity between on the surface part of pellet and on the center part thereof) being more than 0.1 may be used therein.

JP-A-2000-93296 discloses that a thermally resistant paper container prepared by laminating a PBT resin with a terminal carboxyl group content at less than 60 meq/kg on a thermally resistant paper and then molding the resulting laminate has great moldability and thermal resistance without any transfer of the polymer odor to food products therein and is therefore very suitable as a thermally resistant container for cooking under heating at high temperature. Even in this reference, it is described that a paper pretreated by corona discharge is used so as to improve the adhesion of the PBT resin to the paper. However, disadvantageously, simple lamination of the PBT resin onto the paper cannot give enough adhesiveness. Additionally, the reference never describes that a laminate paper with all of great extrusion properties, container processability, color and PBT adhesion to paper can be produced by selecting a specific PBT resin with specific physico-chemical properties. The reference exemplifies a solid phase polymerization process in particular as a PBT production process. When a solid phase polymerization process is employed, generally, the intrinsic viscosity difference ΔIV (difference in intrinsic viscosity between on the surface part of pellet and on the center part thereof) of PBT is at a value larger than 0.1.

Therefore, the development of a laminate paper with properties in good overall balance has been desired.

When PBT laminate paper is prepared into a plate form and a great number of the resulting plate are overlaid together or are wound in a roll shape for long-term storage, furthermore, the surface and back of the plate adhere to each other. When such PBT laminate paper is thermally molded into a container shape, additionally, it often occurs that the mold cavity face and the PBT resin face fuse together; or the paper face and the PBT resin face fuse together; or the PBT resin fuses to each other. When the adhering PBT laminate papers are drawn off or are released from the mold or when paper containers molded from the PBT laminate papers as stored in stack are then to be separated individually all at once, visually observable trace (the trace is abbreviated as release trace hereinafter) remains on the adhering or fused part. The release trace deteriorates the appearance of the paper containers to significantly deteriorate the merchandise value. Although a PBT laminate paper capable of overcoming the problem has been desired, not any of the four references includes any description or suggestion about the problem of release trace.

### SUMMARY OF THE INVENTION

In such circumstances, the invention has been achieved. It is an object of the invention to provide a polyester resin with all of great extrusion properties, container processability, color, releasability and adhesion; a paper laminated with the polyester resin (polyester laminate paper); a method for producing the polyester laminate paper; and a paper container prepared by using the polyester laminate paper.

So as to attain the object, the present inventors made investigations. Consequently, the inventors found that a polyester resin with overall great properties such as all of great extrusion properties, container processability, color and PBT adhesion to paper for use in laminate paper could be obtained by selecting a specific PBT resin satisfying both of (1) a specific melt tension and (2) a specific intrinsic viscosity difference (the difference on the surface part of pellet and the center part thereof) among various PBT resins. Further, the inventors found that a polyester resin composition with great extrusion properties, releasability and adhesiveness could be obtained by blending a specific amount of a release agent in the PBT resin. Thus, the invention has been achieved.

In a first aspect, the invention relates to a polyester resin (A) in a pellet form containing a butylene terephthalate recurring unit as the main component, which is for use in laminate paper and where the polyester resin has (1) a melt tension of 0.5 to 2.5 mN at 250° C. and (2) a difference (ΔIV) between the intrinsic viscosity of pellet surface part IV (S) and the intrinsic viscosity of pellet center part IV (C) being 0.1 or less.

Additionally, the invention relates to a polyester laminate paper prepared by extruding and laminating the resin (A) on at least one of the faces of a paper, a method for producing a polyester laminate paper including extruding and laminating the resin (A) on at least one of the faces of paper, and a polyester laminate paper container prepared by molding the polyester laminate paper.

In a second aspect, the invention relates to a polyester resin composition for use in laminate paper, as prepared by blending a release agent in a polyester resin containing the butylene terephthalate recurring unit as the main component to 0.001 to 5.0% by weight.

In accordance with the invention, film winding or neck-in phenomenon observed in the production of laminate papers in the related art can significantly be improved, so that a polyester laminate paper with all of great extrusion properties, container processability, color and adhesiveness can be obtained. Because the resin containing the butylene terephthalate recurring unit as the main component is used as the constitutional element of the polyester laminate paper, the laminate paper has so great barrier properties and thermal resistance that the laminate paper is preferable for long-term storage of foods containing water or oil and for containers for cooking under heating in microwave oven and simple oven range.

In accordance with the invention, furthermore, there is provided a laminate paper with great extrusion properties and adhesiveness and also with great so-called releasability without any occurrences of the adhesion of the surface and back of the laminate paper to each other even under long-term storage, of the fusion of the polybutylene terephthalate resin face to the mold cavity face during thermal molding and of the release trace even when the laminate paper is molded into a paper container, and accordingly with high merchandise value due to the good appearance, owing to the use of the PBT resin composition in blend with a release agent.

### BEST MODE FOR CARRYING OUT THE INVENTION

The polyester resin for use in laminate paper in accordance with the invention and the like are described in detail hereinbelow. The following descriptions of the constitutional requirements are sometimes based on representative embodiments of the invention. However, the invention is never limited to such embodiments. It should now be noted that, in this specification, any notation using a word “to” indicates a range defined by values placed before and after such word, where both ends of such range are included as minimum and maximum values.

The polyester resin containing the butylene terephthalate recurring unit as the main component to be used in accordance with the invention is a polyester obtained by polymerizing together 1,4-butanediol as a polyhydric alcohol component and terephthalic acid or an ester-forming derivative thereof as a polycarboxylic acid component. The phrase “containing the butylene terephthalate recurring unit as the main component” means that the butylene terephthalate unit occupies 70 mol % or more of the total polycarboxylic acid-polyhydric alcohol units. The butylene terephthalate unit is at preferably 80 mol % or more, more preferably 90 mol % or more and particularly preferably 95 mol % or more.

The polycarboxylic acid component to be used in the polyester resin except terephthalic acid includes for example aromatic polycarboxylic acids such as 2,6-naphthalane dicarboxylic acid, 2,7-naphthalene dicarboxylic acid, isophthalic acid, phthalic acid, trimesic acid and trimellitic acid; aliphatic dicarboxylic acids such as oxalic acid, malonic acid, succinic acid, glutaric acid, adipic acid, suberic acid, azelaic acid, sebacic acid and decanedicarboxylic acid; alicyclic dicarboxylic acids such as cyclohexane dicarboxylic acid; or ester-forming derivatives (for example, lower alkyl esters of polycarboxylic acids, such as dimethyl terephthalate) of the polycarboxylic acids described above. These polycarboxylic acids may be used singly or plurally in combination with terephthalic acid.

Meanwhile, polyhydric alcohols except 1,4-butanediol include for example aliphatic polyhydric alcohols such as ethylene glycol, diethylene glycol, propylene glycol, neopentyl glycol, pentanediol, hexanediol, glycerin, trimethylolpropane, and pentaerythritol; alicyclic polyhydric alcohols such as 1,4-cyclohexanedimethanol; aromatic polyhydric alcohols such as bisphenol A and bisphenol Z; and polyalkylene glycols such as polyethylene glycol, polypropylene glycol, polytetramethylene glycol and polytetramethylene oxide glycol. These polyhydric alcohols may be used singly or plurally in combination with 1,4-butanediol.

The polyester resin in accordance with the invention may be a single type as long as the polyester resin type satisfies the requirements of the invention. Otherwise, the polyester resin may be a polyester resin prepared by melting a mixture of plural polyester resin types with difference in terminal carboxyl group concentrations, melting points, catalyst amounts and the like and then molding the mixture into a pellet form.

Additionally, titanium compounds are generally used as the catalyst for producing the polyester resin. The titanium compounds specifically include for example inorganic titanium compounds such as titanium oxide and titanium tetrachloride; titanium alcolates such as tetramethyl titanate, tetraisopropyl titanate and tetrabutyl titanate; and titanium phenolates such as tetraphenyl titanate. Among them, tetraalkyl titanate is preferable. Specifically, tetrabutyl titanate is particularly preferable.

In addition to titanium compounds, tin compounds may also be used in combination as the catalyst. The tin compounds specifically include for example dibutyltin oxide, methylphenyltin oxide, tetraethyltin, hexaethylditin oxide, cyclohexahexylditin oxide, didodecyltin oxide, triethyltin hydroxide, triphenyltin hydroxide, triisobutyltin acetate, dibutyltin diacetate, diphenyltin dilaurate, monobutyltin trichloride, tributyltin chloride, dibutyltin sulfide, butylhydroxytin oxide, methylstannate, ethylstannate, and butylstannate.

In addition to the titanium compounds, auxiliary reaction agents may be used in combination and includes for example magnesium compounds such as magnesium acetate, magnesium hydroxide, magnesium carbonate, magnesium oxide, magnesium alkoxide, and magnesium hydrogen phosphate; calcium compounds such as calcium acetate, calcium hydroxide, calcium carbonate, calcium oxide, calcium alkoxide, and calcium hydrogen phosphate; antimony compounds such as antimony trioxide; germanium compounds such as germanium dioxide, and germanium tetraoxide; manganese compounds; zinc compounds; zirconium compounds; cobalt compounds; phosphor compounds such as phosphoric acid, phosphorous acid, hypophosphorous acid, polyphosphoric acid, and esters and metal salts thereof; sodium hydroxide and sodium benzoate.

In the first aspect, the invention relates to the polyester resin (A) with a specific melt tension and a specific intrinsic viscosity difference.

A first characteristic feature of the polyester resin (A) is its melt tension of 0.5 to 2.5 mN at 250° C. The melt tension can be determined for example by a capillograph manufactured by Toyo Seiki Seisaku-Sho, Ltd. Melt tension has a close relation with extrusion properties and container processability. From the respect of high-speed lamination, the lower limit of the melt tension is preferably 0.55 or more, more preferably 0.60 or more and still more preferably 0.65 or more. The upper limit is preferably 2.0 or less, more preferably 1.80 or less, still more preferably 1.40 or less and particularly preferably 1.30 or less. When the melt tension is less than 0.5 mN, the neck-in phenomenon of the polyester resin (A) during extrusion is so severe that the trim of the polyester laminate paper is significantly small compared with the T die width or that the difference in polyester thickness between on the center part and on the end part after lamination significantly increases. Unpreferably, therefore, the polyester laminate paper thus obtained cannot be used for molding process. When the melt tension is far larger than 2.5 mN, alternatively, the load on extruder in that case is so large that the extruded amount is limited, leading to not only the occurrence of the deterioration of high-speed extrusion but also significant decrease of the adhesion between the polyester resin (A) and the paper face.

A second characteristic feature of the polyester resin (A) is the difference ΔIV in intrinsic viscosity IV between on the pellet surface part (S) and on the pellet center part (C) [ΔIV=|IV(S)−IV(C)|] being 0.1 or less, which works for improving the adhesion of the polyester resin to thermally resistant paper. When ΔIV exceeds 0.1, unpreferably, the adhesion of PBT to paper is deteriorated. Although the reason cannot be clearly shown in detail, the intrinsic viscosity difference between on the surface part of pellet and on the center part of pellet is so small when ΔIV is 0.1 or less that the molecular weight distribution of the polyester resin (A) is likely homogenous and the content of components with higher molecular weights is likely less. Thus, it is understood that the polyester resin (A) to be laminated readily permeates through thermally resistant paper, so that the adhesiveness will be improved. A pellet with ΔIV more than 0.1 has a larger pressure variation during extrusion, so that non-uniform film thickness emerges or the resulting film winds, unpreferably. ΔIV is preferably 0.05 or less, more preferably 0.03 or less and still more preferably 0.01 or less.

In accordance with the invention, the phrase “intrinsic viscosity difference (ΔIV) between on the surface part of pellet (S) and on the center part of pellet (C)” means the difference between the intrinsic viscosity IV(S) of a part (surface part) within 5±1% by weight from the outer periphery of pellet and the intrinsic viscosity IV(C) of a part (center part) within 5±1% by weight from the pellet center.

The intrinsic viscosity at the surface part and center part of pellet can be determined by leaving alone the pellet in a solvent solubilizing PBT, exchanging the solvent with fresh such solvent and repeating the procedure over time to obtain a series of PBT solution fractions starting from the pellet surface, removing the solvent individually from the first fraction first solubilizing the pellet and to the final fraction completely solubilizing the pellet, separately obtaining PBTs individually from the pellet surface part and the center part, and measuring the intrinsic viscosity of each of the PBTs. The solvent for use herein is hexafluoroisopropanol, o-chlorophenol, and a mixture solvent of tetrachloroethane/phenol.

So as to obtain a fraction within 5±1% by weight from the outer periphery or center part of pellet, the solubility of the pellet in the solvent is preliminarily determined. Depending on the solubility, a fraction within 5±1% by weight of the whole pellet may be collected or some fractions may be collected every short time to be mixed together so as to constitute a range within 5±1% by weight of the whole pellet, to obtain the surface part and center part of the pellet.

In case that solid phase polymerization is carried out, generally, ΔIV likely increases when the increase of the mean IV of the whole pellet before and after solid phase polymerization is large.

In accordance with the invention, the term pellet shape means a pellet in granule with any shape and includes for example but is not limited to cylindrical shape, sphere shape or plate shape. Typically, the pellet shape is a cylindrical shape. When the pellet size is too large, ΔIV is likely too large. When the pellet size is too small, such pellet causes bridging or poor encroachment during molding. In accordance with the invention, therefore, the pellet size is as follows: when the pellet is in a cylindrical shape, the mean diameter of the pellet, namely the mean of the short diameter and long diameter of the vertically cross section along the longitudinal direction of the pellet is at the upper limit of preferably 5.0 mm, more preferably 4.0 mm, still more preferably 3.5 mm, and particularly preferably 3.0 mm and at the lower limit of preferably 1.0 mm, more preferably 1.5 mm, still more preferably 2.0 mm, and particularly preferably 2.5 mm (the mean can be determined by summing up the short diameter and long diameter of the vertically cross section along the longitudinal direction of each of 100 pellets to be appropriately selected for lamination dividing the sum by 2, and then determining the average of the resulting values).

Due to the same reason, the mean length of the pellet along the longitudinal direction of the pellet (the mean length can be determined by measuring the length of each of 100 pellets appropriately selected from pellets to be laminated along the longitudinal direction and averaging the resulting values) is generally 1 to 6 mm, and particularly preferably 2 to 4 mm.

In case that the pellet is in a sphere shape, the mean diameter of the sphere corresponds to the mean diameter described above. In case that the pellet is in a plate shape, the mean thickness of the plate corresponds to the mean diameter while the longest dimension of the plate corresponds to the mean length.

When 100 pellets of the polyester resin (A) for use in accordance with the invention are sampled and weighed, the pellet weight is generally 1.8 g to 3.5 g, preferably 2.0 to 3.0 g, and more preferably 2.1 to 2.6 g.

In accordance with the invention, the pellet polyester resin (A) with ΔIV of 0.1 or less can be produced by any of melt polymerization process or a solid phase polymerization process including melt polymerization and subsequent solid phase polymerization under mild conditions. Additionally, any of continuous process and batch-wise process may be satisfactory. Among them, a melt polymerization process by continuous process is preferable because a pellet with ΔIV of 0.1 or less can thereby be produced readily.

In accordance with the invention, the melt polymerization process preferably includes but is not limited to continuous polymerization using a reactor of a linear continuous tank type. For example, a dicarboxylic acid component and a diol component are continuously esterified in the presence of an esterification catalyst in one unit or plural units of an esterification tank at a temperature of preferably 150 to 280° C. and more preferably 180 to 265° C. and a pressure of preferably 6.67 to 133 kPa and more preferably 9.33 to 101 kPa under agitation for 2 to 5 hours, to obtain an oligomer as the esterification product, which is then transferred into one unit or plural units of a polycondensation tank, where the oligomer is continuously polymerized and condensed together in the presence of a polycondensation catalyst at a temperature of preferably 210 to 280° C. and more preferably 220 to 265° C. and under a reduced pressure of preferably 26.7 kPa or less and more preferably 20 kPa or less under agitation for 2 to 5 hours. The polybutylene terephthalate resin obtained by the polycondensation is transferred from the bottom of the polycondensation tank to a polymer extract die, where the resin is extracted in a strand form, which is then cut with a pelletizer under cooling with water or after cooling with water, to be prepared into a pellet shape.

The polyester resin (A) with ΔIV of 0.1 or less for use in accordance with the invention may also be produced by melt polymerization and subsequent solid phase polymerization. For example, ester exchange reaction or esterification followed by polycondensation reaction is done by a melt polymerization process by batch-wise process, to prepare a polyester resin with a relatively high intrinsic viscosity, which is then polymerized in a solid phase under mild conditions such as heating under reduced pressure of 1.33 to 26.6 kPa and 160 to 170° C. for one to 2 hours.

Because ΔIV possibly exceeds 0.1 under more or less severe conditions such as those common for solid phase polymerization, for example heating under a reduced pressure of 0.1 kPa or less at about 200° C. for 7 to 10 hours, such conditions are not preferable as conditions for producing the polyester resin (A).

The type of the esterification tank is not specifically limited. For example, the esterification tank includes for example complete mixing tank of longitudinal agitation type, mixing tank of longitudinal thermal convection type, and continuous reaction tank of tower type. Esterification tank may be one unit or may be plural tanks consisting of plural units of same type or different types in linear arrangement. The type of the polycondensation tank for use in accordance with the invention includes for example but is not specifically limited to polymerization tank of longitudinal agitation type, polymerization tank of crosswise agitation type, and polymerization tank of thin film evaporation type. The polymerization tank may be one unit or may be plural tanks consisting of plural units of same type or different types in linear arrangement.

In accordance with the invention, a layer comprising a polyester resin (B) may be laminated via co-extrusion on the layer comprising the polyester resin (A) to be laminated on the surface of paper, to produce a layered polyester laminate paper.

In producing the layered polyester laminate paper, a resin with a melt viscosity of 500 Pa·S or less at 250° C. with a shear velocity of 91.2 sec⁻¹ is preferably used as the polyester resin (A). The melt viscosity can be measured for example by a capillograph manufactured by Toyo Seiki Seisaku-Sho, Ltd. In such manner, the adhesion between paper and the polyester laminate film can be increased even when the melt tension of a polyester resin to be used as the polyester resin layer (B) to be laminated on the surface of the polyester resin layer (A) is relatively high. When the melt viscosity is 500 Pa·S or less, a laminate paper with great adhesion to paper and good container processability can likely be obtained. The upper limit of the melt viscosity is preferably 450 Pa·S or less, more preferably 400 Pa·S or less and particularly preferably 350 Pa·S or less, while the lower limit is preferably 100 Pa·S or more and more preferably 150 Pa·S or more. Such melt viscosity can be obtained by adjusting the polymerization time, the reduced pressure level, the temperature and the like during a process of producing the polyester.

In producing the layered polyester laminate paper, a resin with a melt tension of 1.0 mN or more at 250° C. is preferably used as the polyester resin (B) to be laminated on a face of the layer comprising the polyester resin (A), which is opposite to the face thereof where a paper is laminated. In such manner, a layered laminate paper with great high-speed lamination properties can be produced. Herein, the melt tension can be determined for example with a capillograph manufactured by Toyo Seiki Seisaku-Sho, Ltd. The upper limit of the melt tension is preferably 10 mN or less, more preferably 5.0 mN or less and still more preferably 3.0 mN or less, while the lower limit is preferably 1.1 mN or more and more preferably 1.2 mN or more. The melt tension can be obtained by adjusting the polymerization time, the reduced pressure level, the temperature and the like in a polyester production process.

When the melt tension of the polyester resin (B) is 1.0 mN or more, the neck-in phenomenon during extrusion can readily be suppressed, so that the difference in the thickness of the polyester layer between on the center part and on the end part after lamination is never too large. In molding the laminate paper into a container or in bending such container, it is likely that cracks or pin-holes on the polyester layer hardly emerge. When the melt tension is 10 mN or less, the extruded amount is relatively freely controlled to enable high-speed extrusion, so that high adhesion to paper is likely realized.

The polyester resin (B) may be produced by any of melt polymerization process or a solid phase polymerization process following melt polymerization and by continuous process or batch-wise process. A melt polymerization process by continuous process is more preferable from the respect of stable extrusion with a uniform load on the extruder screw during the plasticization of polymerized pellet and with less non-uniformity in the film thickness on paper.

The intrinsic viscosity of the polyester resin (A) in accordance with the invention is 0.8 dl/g or more, preferably 0.9 dl/g or more and more preferably 1.0 dl/g or more, while the upper limit is 1.5 dl/g or less, preferably 1.4 dl/g or less, more preferably 1.3 dl/g or less and particularly preferably 1.2 dl/g or less. When the intrinsic viscosity of the polyester resin (A) is 0.8 dl/g or more, the resulting molded product is likely to have a great mechanical strength. When the intrinsic viscosity thereof is 1.5 dl/g or less, the resin (A) has such a suitable melt viscosity that the flowability thereof is so great and moldability is excellent, and great adhesion of the polyester resin (A) are likely generated practically.

The intrinsic viscosity of the polyester resin (B) in accordance with the invention is 1.0 dl/g or more, preferably 1.1 dl/g or more, and particularly preferably 1.2 dl/g or more. The upper limit thereof is 2.5 dl/g or less, preferably 2.0 dl/g or less and particularly preferably 1.8 dl/g or less. When the intrinsic viscosity of the polyester resin (B) is 1.0 dl/g or more, the resulting molded product likely has a great mechanical strength. When the intrinsic viscosity thereof is 2.5 dl/g or less, the resin (B) has such a suitable melt viscosity that the pellet productivity is likely to be elevated without involving any increase of the load on the extruder screw or any regulation of the extruded amount.

The intrinsic viscosity of PBT in accordance with the invention is a value determined on the basis of the solution viscosity measured at 30° C., using a mixture solvent of phenol and 1,1,2,2-tetrachloroethane at a weight ratio of 1:1.

The crystallization temperature of the polyester resin at temperature decrease for use in accordance with the invention is preferably 170° C. or more and more preferably 175° C. or more, from the respect of the thermal resistance of the container after lamination. The crystallization temperature of the polyester resin at temperature decrease means crystallization temperature measured under a condition of a temperature decrease rate of 20° C./min using the differential scanning calorimeter. The crystallization temperature under temperature decrease is the temperature with the exothermic peak due to crystallization, which appears when PBT is cooled from its melted state at a temperature decrease rate of 20° C./min.

The terminal carboxyl group amount in the polyester resin for use in accordance with the invention is generally 50 eq/t or less, preferably 30 eq/t or less and more preferably 25 eq/t or less. The terminal carboxyl group amount can be determined by dissolving PBT in an organic solvent such as benzyl alcohol and titrating the resulting solution with a solution of sodium hydroxide and the like in benzyl alcohol to neutrality. By adjusting the terminal carboxyl group amount in PBT to 50 eq/t or less, the anti-thermal aging stability (retention stability) of the resin in accordance with the invention can particularly be improved. Additionally, the resistance against hydrolysis can also be improved significantly.

The polyester resins for use in accordance with the invention are individually at a content of titanium atom and tin atom in total being preferably 100 ppm or less. These atoms are contained as titanium compounds and tin compounds as catalyst residues from the polymerization. In case that no tin compound is used in combination with titanium compounds as the catalyst, the polyester resins (A) and (B) substantially never contain tin atom. Therefore, the resins are preferably at a titanium atom content of 100 ppm or less.

In accordance with the invention, further, the content of titanium atom in the polyester resins is preferably adjusted to a specific value so as to reduce the color change of the resulting laminate paper. Specifically, the lower limit of the titanium atom content in the resins is preferably 10 ppm or more, more preferably 15 ppm or more and still more preferably 20 ppm or more. Meanwhile, the upper limit is preferably 90 ppm or less, more preferably 85 ppm or less, still more preferably 80 ppm or less and particularly preferably 70 ppm or less. When the titanium atom content is 100 ppm or less, the neck-in phenomenon of the polyesters are likely suppressed during extrusion lamination, and the yellowish color change or fish eye of the polyesters after extrusion lamination are also likely suppressed. Even by heating the resulting container charged with food products at a high temperature for a long time, it is likely that problems such as appearance change and taste change of food products in contact with the container hardly occur. When the content is 10 ppm or more, the polyester polymerization is likely promoted efficiently. Herein, the content of titanium atom or tin atom can be measured using methods by atomic emission, atomic absorption, induced coupled plasma (ICP) and the like, after the metal in the polymers is recovered by processes such as wet ashing.

The polyester resins of the invention may particularly be blended with a reinforced filler within a range without deteriorating the characteristic profile of the invention. The reinforced filler may be an organic material or an inorganic material. Specific examples include glass fiber, glass flake, milled fiber, glass beads, montmorillonite, mica, talc, kaolin, carbon fiber, whisker, wallastonite, silica, calcium carbonate, barium sulfate, titanium oxide, and alumina. These may be used singly or in combination of plural such fillers.

Within a range without deteriorating the characteristic profile of the invention, the polyester resins may be blended with an appropriate amount of a third component such as resins (for example, engineering plastics such as polyolefin resin, vinyl-series resin, polyamide and polyphenylene ether, and rubber) except polyester, organic crosslinking particles, inorganic particles, thermal stabilizers, antioxidants, antistatic agents, release agents, coloring agents and printability-improving agents.

In a second aspect, the invention relates to a polyester resin composition prepared by blending a specific amount of a release agent in the polyester resin containing the butylene terephthalate recurring unit as the main component.

When blended in the polyester resin, the release agent for use in accordance with the invention functions for greatly improving the releasability of the PBT laminate paper. Herein, the term “releasability” means no adhesion of the surface and back of the PBT laminate paper even when a great number of the PBT laminate paper are overlaid together in a plate form or are wound in a roll shape for long-term storage and additionally means unlikely emergence of release trace on the product paper container when the PBT laminate paper is molded under heating into such product.

The release agent includes for example hydrocarbon-series wax and modified products thereof, higher fatty acid esters, higher fatty acid amides or metal salts of higher fatty acids.

The hydrocarbon-series wax and modified products thereof include for example paraffin wax and polyethylene wax. Paraffin wax is a petroleum wax containing n-paraffin as the main component and has a melt viscosity at 100° C. being preferably 0.1 poise or less and a melting point being preferably within a range of 50 to 90° C. Polyethylene wax is a low molecular polyethylene in a wax appearance and has a molecular weight in the middle of molecular weights of paraffin and polyethylene for molding. Preferably, the hydrocarbon-series wax and modified products thereof have a number average molecular weight within a range of 500 to 15,000.

Higher fatty acid ester is a compound prepared by the esterification of higher fatty acid with monohydric or polyhydric alcohol. Higher fatty acid includes for example stearic acid, oleic acid, octanoic acid, lauric acid, ricinoleic acid, and behenic acid. The carbon atoms in the higher fatty acid are preferably 4 to 40, more preferably 8 to 30 and particularly preferably 10 to 25. Meanwhile, the monohydric or polyhydric alcohol includes for example octyl alcohol, myristyl alcohol, stearyl alcohol, behenyl alcohol, glycols, glycerin, and pentaerythritol. The carbon atoms in monohydric or polyhydric alcohol are preferably one to 40, more preferably 2 to 30, and particularly preferably 3 to 20. The higher fatty acid esters are preferably higher esters such as stearyl stearate and lauryl laurate; long chain fatty acid triglycerides such as glycerin tristearate and glycerin trilaurate; long chain fatty acid diglycerides such as glycerin distearate and glycerin dilaurate; and long chain fatty acid monoglycerides such as glycerin monostearate, glycerin monooleate, and glycerin monolaurate.

The higher fatty acid amides include for example N-oleyl palmitoamide, N-stearylerucamide, ethylene bisstearylamide, and ethylene bisoleylamide.

The metal salts of higher fatty acids include for example compounds of metals such as calcium, magnesium and sodium with higher fatty acids such as stearic acid, 12-hydroxystearic acid, oleic acid, octanoic acid, behenic acid and recinoleic acid. The carbon atoms therein are preferably 4 to 40, more preferably 8 to 30 and particularly preferably 10 to 20.

The release agent preferably includes hydrocarbon-series wax and modified products thereof or higher fatty acid esters and more preferably includes paraffin wax and polyethylene wax as hydrocarbon-series wax and modified products thereof. Still more preferably, the release agent is paraffin wax.

The amount of the release agent in blend is within a range of 0.001 to 5.0% by weight of the polyester resins. When the amount is less than 0.001% by weight, the releasability is so insufficient that fusion occurs between the mold cavity face and the laminate paper container or in the laminate paper container to each other during thermal molding. When the molded paper container is released from the mold or when plural such molded paper containers at overlaid state are individually separated, thus, release trace emerges to deteriorate the container appearance and reduce the merchandise value. When the amount exceeds 5.0% by weight, the bleed-out of the release agent likely occurs. Accordingly, the release agent at that amount when blended in the polyester resins for lamination with paper causes poor adhesion to paper or the bleed-out release agent stains the mold cavity face on thermal molding or sometimes adversely affects the taste of food products placed in the resulting paper container. The release agent may be blended singly or in combination of two or more such types. The amount of the release agent in blend is within a range of preferably 0.01 to 4.0% by weight, more preferably 0.05 to 3.5% by weight and most preferably 0.1 to 3.0% by weight.

In accordance with the invention, furthermore, lamellar silicate salts are blended in the polyester resins to greatly improve the releasability and thermal resistance of the resulting laminate paper.

The lamellar silicate salts include for example smectite-series clay minerals, swelling synthetic mica, vermiculite, fluorine vermiculite or halloysite of 2:1 type, where an octahedron sheet structure containing Al, Mg and Li is sandwiched with two sheets of a silicate tetrahedron structure. The smectite-series clay mineral includes for example montmorillonite, hectolite, fluorine hectolite, saponite, bidenite, and stibinesite. The swelling synthetic mica includes for example Li type fluorine teniolite represented by the following formula (I), Na type fluorine teniolite represented by the following formula (II), and Na type tetrasilicone fluorine mica represented by the following formula (III). Among them, smectite-series clay minerals and swelling synthetic mica are preferable. Montmorillonite obtained by purifying bendoit and swelling synthetic mica are more preferable. These are not necessarily derived from natural origins but may be treated by modification processes for example for organic introduction in between the layers of lamellar silicate salts as described below. Additionally, the chemical formulas of (I) through (III) represent ideal compositions. Therefore, not any strict agreement with the formulas is required.
LiMg₂Li(Si₄O₁₀)F₂ (I)
NaMg₂Li(Si₄O₁₀)F₂ (II)
NaMg₂₅(Si₄O₁₀)F₂ (III)

The amount of the lamellar silicate salts in blend is preferably within a range of 0.1 to 20% by weight of the polyester resins. When the amount is less than 0.1% by weight, the releasability is so insufficient that fusion occurs between the mold cavity face and the laminate paper container or in the laminate paper container to each other on thermal molding. When the molded paper container is released from the mold or when plural such molded paper containers in the overlaid state are individually separated, thus, release trace likely emerges. When food products are placed in the resulting laminate paper container for cooking under heating at about 200° C., the thermal resistance is so insufficient that the container likely deforms to deteriorate the merchandise value. When the amount exceeds 20% by weight, the bleed-out of the lamellar silicate salts gets notable. Accordingly, the lamellar silicate salts at that amount when blended in the polyester resins for lamination with paper cause poor adhesion to paper or the bleed-out lamellar silicate salts make the mold cavity face dirty on thermal molding or sometimes adversely affect the taste of food products charged in the resulting paper container. The lamellar silicate salts may be blended singly or in combination of two or more types thereof. The amount of the lamellar silicate salts in blend is within a range of more preferably 0.2 to 15% by weight and most preferably 0.5 to 10% by weight.

So as to allow the laminate paper to exert excellent releasability and thermal resistance, the lamellar silicate salts are preferably dispersed uniformly in the polyester resins. For the uniform dispersion, the lamellar silicate salts are treated at a modification process, to introduce organic onium ions in between the layers. The organic onium ions for use in the modification process include for example ammonium ion, phosphonium ion, sulfonium ion, and onium ions derived from heteroaromatic rings. From the respect of ready availability and stability, preferable are ammonium ion, phosphonium ion and onium ions derived from heteroaromatic rings.

Ammonium ion for use in the modification process includes for example alkyl ammonium such as hexyl ammonium, octyl ammonium, decyl ammonium, dodecyl ammonium, hexadecyl ammonium and octadecyl ammonium; ω-aminoaliphatic carboxylic acid ammonium including ω-aminoaliphatic carboxylic acid such as 6-aminohexanoic acid, 7-aminoheptanoic acid, 8-aminooctanoic acid, 9-aminononanoic acid, 10-aminodecanoic acid, 11-aminoundecanoic acid, and 12-aminododecanoic acid; primary ammoniums including alpha-amino acid such as glycine, alanine, valine, leucine, isoleucine, phenylalanine, tyrosine, threonine, serine, proline, hydroxyproline, tryptophan, thyroxin, methionine, cystine, cysteine, aspartic acid, glutamic acid, asparagine, glutamine, lysine, arginine, and histidine; secondary ammoniums such as methyldodecyl ammonium, butyldodecyl ammonium, and methyloctadecyl ammonium; tertiary ammoniums such as dimethyldodecyl ammonium, dimethylhexadecyl ammonium, dimethyloctadecyl ammonium, diphenyldodecyl ammonium, and diphenyloctadecyl ammonium; quaternary ammoniums including quaternary ammonium with same alkyl groups such as tetraethyl ammonium, tetrabutyl ammonium and tetraoctyl ammonium, trimethylalkyl ammonium such as trimethyloctyl ammonium, trimethyldecyl ammonium, trimethyldodecyl ammonium, trimethyltetradecyl ammonium, trimethylhexadecyl ammonium, trimethyloctadecyl ammonium, trimethyleicosanyl ammonium, trimethyloctadecenyl ammonium and trimethyloctadecadienyl ammonium, triethylalkyl ammonium such as triethyldodecyl ammonium, triethyltetradecyl ammonium, triethylhexadecyl ammonium, and triethyloctadecyl ammonium, tributylalkyl ammonium such as tributyldodecyl ammonium, tributyltetradecyl ammonium, tributylhexadecyl ammonium, and tributyloctadecyl ammonium, dimethyldialkyl ammonium such as dimethyldioctyl ammonium, dimethyldidecyl ammonium, dimethylditetradecyl ammonium, dimethyldihexadecyl ammonium, dimethyldioctadecyl ammonium, dimethyldioctadecenyl ammonium, and dimethyldioctadecadienyl ammonium, diethyldialkyl ammonium such as diethyldidodecyl ammonium, diethylditetradecyl ammonium, diethyldihexadecyl ammonium, and diethyldioctadecyl ammonium, dibutyldialkyl ammonium such as dibutyldidodecyl ammonium, dibutylditetradecyl ammonium, dibutyldihexadecyl ammonium and dibutyldioctadecyl ammonium, methylbenzyldialkyl ammonium such as methylbenzyldihexadecyl ammonium, dibenzyldialkyl ammonium such as dibenzyldihexadecyl ammonium, trialkylmethyl ammonium such as trioctylmethyl ammonium, tridodecylmethyl ammonium, and tritetradecylmethyl ammonium, trialkylethyl ammonium such as trioctylethyl ammonium and tridodecylethyl ammonium, trialkylbutyl ammonium such as trioctylbutyl ammonium and tridodecylbutyl ammonium, quaternary ammonium with aromatic ring such as trimethylbenzyl ammonium, and aromatic amine-derived quaternary ammonium such as trimethylphenyl ammonium.

Among them, preferable are trimethyl-long chain alkyl ammonium such as trimethyldecyl ammonium, trimethyldodecyl ammonium, trimethyltetradecyl ammonium, trimethylhexadecyl ammonium, and trimethyloctadecyl ammonium, triethyl-long chain alkyl ammonium such as triethyldodecyl ammonium, triethyltetradecyl ammonium, triethylhexadecyl ammonium, and triethyloctadecyl ammonium, dimethyldialkyl ammonium such as dimethyldidecyl ammonium, dimethylditetradecyl ammonium, dimethyldihexadecyl ammonium, and dimethyldioctadecyl ammonium, diethyldialkyl ammonium such as diethyldidodecyl ammonium, diethylditetradecyl ammonium, diethyldihexadecyl ammonium, and diethyldioctadecyl ammonium. More preferable are trimethyl-long chain alkyl ammonium and dimethyldialkyl ammonium. Among the above ammonium ions, dimethyldialkyl ammonium is the most preferable.

Phosphonium ion for use in the modification process includes for example alkyl quaternary phosphonium such as tetrabutyl phosphonium, tetraoctyl phosphonium, trimethyldecyl phosphonium, trimethyldodecyl phosphonium, trimethylhexadecyl phosphonium, trimethyloctadecyl phosphonium, tributyldodecyl phosphonium, tributylhexadecyl phosphonium, and tributyloctadecyl phosphonium, and quaternary phosphoniums such as phenylalkyl quaternary phosphoniums including phenyltrimethyl phosphonium, phenyltributyl phosphonium, diphenyldimethyl phosphonium, triphenylmethyl phosphonium and tetraphenyl phosphonium. These organic onium ions may be used singly or in mixture of two or more types thereof.

By treating the lamellar silicate salts with an organic onium ion at a modification process, organic structures can be introduced in between the layers in the negatively charged silicate salt layer to improve the dispersibility of the lamellar silicate salts in the polyester resins. The modification process for introducing such organic onium ion in between the layers in the lamellar silicate salts may be a process of adding an organic onium ion or an aqueous solution containing the organic onium ion to aqueous suspensions of the lamellar silicate salts for cation exchange. So as to effectively promote the introduction of the organic onium ion in between the layers, the cation exchange capacity (CEC) of the lamellar silicate salts is preferably 30 meq/100 g or more. When the cation exchange capacity is less than 30 meq/100 g or less, the amount of the organic onium ion introduced in between the layers in the lamellar silicate salts is so insufficient that the dispersibility of the lamellar silicate salts in the polyester resins cannot be improved, thus causing insufficiency in the releasability exertion. The amount is more preferably 50 meq/100 g or more and still more preferably 70 meq/100 g or more. The amount of the organic onium ion to be introduced in the layers is preferably within a range of 0.8 to 2.0 equivalents of the cation exchange capacity of the lamellar silicate salts as raw materials. When the amount is less than 0.8 equivalent, the dispersibility thereof in the polyester resins cannot be improved, so that the releasability gets insufficient. When the amount exceeds 2.0 equivalents, disadvantageously, free compounds derived from the organic onium ion significantly increase, causing the deterioration of thermal stability during thermal molding, the fuming of the free compounds, the staining of mold cavity face, and odor transfer to food products placed in the resulting paper container. The amount is more preferably within a range of 0.9 to 1.3 equivalents.

In accordance with the invention, any known process of blending various additives and other resins into the polyester resins may be satisfactory with no specific limitation. The process includes for example (1) a process of blending various additives and other resins in the production process of the polyester resins, (2) a process of dry blending such additives and other resins in the polyester resins in pellet forms, (3) a process of preliminarily mixing a part of the polyester resins with other resins or additives or the like to prepare a master batch and mixing the master batch with the remaining polyester resins, or (4) a process of blending such additives and other resins during the melt kneading of the polyester resins for lamination.

The paper for use in accordance with the invention includes paper and paperboard based on the classification according to Japan Paper Association, and non-woven fabric. The paper based on the classification according to Japan Paper Association includes for example processed base paper such as base paper for cup, pure white roll paper, packaging paper such as craft paper, high-quality paper, printing and information paper such as inkjet paper, and functional paper prepared by blending synthetic resin-made fiber such as polyester resin. The paperboard includes for example coat board. Among them, preferable are paperboard for paper container, pure white roll paper, and bleached craft paper, from the respect of molding of containers for food products. Such paper may wholly be colored or its surface may be printed with characters, patterns, pictures and the like.

The levelness degree of the paper in accordance with the invention can be determined by the measurement according to JIS P8119 and is preferably 10 seconds or more, more preferably 50 seconds or more, still more preferably 100 seconds or more and particularly preferably 200 seconds or more, from the respect of the adhesion to polyester. When the levelness degree is 10 seconds or more, the intrinsic viscosity of the polyester resin (A) cannot be necessarily reduced so as to allow the polyester resin (A) to closely adhere to paper, so that the film necking phenomenon from the stage with T die to the stage for film lamination on paper can likely be suppressed, leading to the increase of the productivity. Additionally, the weight of such paper is generally 10 to 500 g/m², preferably 15 to 400 g/m², and more preferably 20 to 300 g/m².

The polyester laminate paper of the invention can be obtained by laminating the polyester resin or the resin composition prepared into a film on paper. The polyester laminate paper of the invention includes laminate papers on both the faces thereof being laminated in addition to laminate papers on at least one of the faces thereof being laminated. Via lamination, functions such as releasability, thermal resistance, water resistance and oil resistance can be given to the resulting paper. The paper face without the lamination of the polyester resin composition may be left as it is or may be laminated with the polyester resin composition or a film or sheet made of another resin or may be laminated with a laminate thereof. The film or sheet made of another resin may be preliminarily colored or may be printed with characters, patterns and pictures. When a picture or the like is printed on the film or sheet made of another resin to form a polyester layer on the surface, the picture or the like is never exposed to the surface. Therefore, a laminate paper with beautiful appearance can be prepared. The film or sheet made of another resin includes for example thermoplastic resins other than the polyester resins, and aluminium foil or may be a foam.

The process of molding the polyester laminate paper in accordance with the invention includes for example but is not limited to any of various known processes. As a specific example, a paper laminated with the polyester resin can be obtained by melt kneading with a screw extruder the polyester resin in a pellet form sufficiently dried, continuously extruding the melt film from T die onto the thermoresistant paper as a base, and winding the resulting extruded film with a chill roll under cooling at a pressure. In case of intending to produce a polyester laminate paper with a laminate of the resin (A) and the resin (B), the resin (A) and the resin (B) in chips sufficiently dried are separately melt kneaded with an individual extruder; the resulting resin (A) and resin (B) encounter each other in, for example, a lamination die of field block type, through a tube and then co-extruded continuously onto the base paper and wound with a chill roll under cooling at a pressure.

The air gap during co-extrusion is generally 15 cm or less, preferably 10 cm or less, and more preferably 8 cm or less. When the air gap is 15 cm or less, the temperature of the melt films is never too lowered until lamination. Therefore, good adhesion to the paper is likely realized.

The extrusion temperature of the polyester resin during the molding of the polyester laminate paper is generally 230 to 320° C., preferably 240 to 310° C., more preferably 250 to 305° C., still more preferably 255 to 300° C. and particularly preferably 260 to 295° C. When the resin temperature is 320° C. or less, neck-in phenomenon and end disorders because of thermal decomposition hardly occur. Additionally, high-speed polyester extrusion can be done without the deterioration of the extrusion properties, owing to the increase of trimming level. Thus, the yellow discoloration of the laminated polyester is suppressed, so that sufficient odor-keeping properties and taste-keeping properties are likely generated. Additionally, the chill roll temperature is generally 20° C. or more, preferably 30° C. or more and more preferably 40° C. or more.

In accordance with the invention, additionally, a gas-barrier resin layer of nylon and EVOH (ethylene-vinyl alcohol copolymer) is co-extruded through an adhesive layer in between the layer comprising the polyester resin (A) and the layer comprising the polyester resin (B), to produce a layered laminate paper with great gas barrier properties.

The film thickness of the polyester film to be laminated on paper is generally 25 μm or less, preferably 20 μm or less, and more preferably 15 μm or less. Meanwhile, the lower limit thereof is generally 5 μm or more, preferably 8 μm or more and more preferably 10 μm or more. By using the polyester resin (A) of the invention, a laminate paper with great adhesiveness even at a small film thickness can be produced.

Additionally, the film thickness of the whole layered polyester film after the co-extrusion of the resin (A) and the resin (B) and subsequent lamination is with no specific limitation but is generally 1 to 100 μm, preferably 5 to 50 μm, and particularly preferably 10 to 25 μm. When the film thickness is 1 μm or more, defects such as pin hole hardly occur during molding process. When the film thickness is 100 μm or less, excellent container processability is likely realized in a ready manner.

For producing a layered polyester laminate paper, the resin (A) and the resin (B) are preferably laminated together during lamination on the paper, so that the ratio of the film thickness values of the individual resins after lamination [d(resin B)/d (resin A)] [the ratio of the film thickness values is referred to as d(B)/d(A) hereinafter] might be 0.5 to 50. In such manner, a laminate paper with all of excellent extrusion properties, container processability and adhesiveness can be produced. When d(B)/d(A) is 0.5 or more, necking can be suppressed, leading to the tendency of ready high-speed lamination. When the ratio is 50 or less, great adhesiveness and container processability are likely realized. So as to adjust the ratio of the film thickness values to a range of 0.5 to 50, the extrusion amounts of two extruders should be adjusted.

The ratio of the film thickness values described above [d(B)/d(A)] is preferably with a lower limit of 1.0 or more, preferably 2.0 or more, and particularly preferably 3.0 or more and with an upper limit of 30 or less, preferably 20 or less and particularly preferably 10 or less, so as to produce a laminate paper with all of excellent extrusion properties, container processability and adhesiveness.

The polyester laminate paper thus obtained in accordance with the invention is preferable as a resin material with excellent adhesiveness, thermal resistance and moldability for paper container and can preferably be used for storage of food products containing moisture and oily matters or as paper containers of food products demanding thermal resistance at high temperature for heating in microwave oven and in simple oven range, such as frozen food products and refrigerated food products. The laminate paper container can be obtained by cutting the polyester laminate paper into an appropriate dimension, transferring a single sheet or plural sheets in a layered stack of the laminate paper in a plane form all at once into a mold, or transferring the laminate paper into a mold while unwinding the laminate paper preliminarily wound in a roll form, and thermally molding the transferred one. Any known method in the related art may be satisfactory as the thermal molding method and includes for example vacuum molding method, air-pressure forming method and press molding method. The temperature during molding under heating is generally 90 to 160° C., preferably 100 to 150° C. and more preferably 110 to 140° C.

The characteristic features of the invention are more specifically described below in the following Examples and Comparative Examples. The materials, the amounts thereof to be used, the ratio thereof, the contents of the treatment thereof, the procedures for the treatment thereof and the like as described in the following Examples may appropriately be modified without departing from the spirit of the invention. Herein, the scope of the invention should never be understood in a limited manner to the following specific examples. Additionally, there are described below the method for measuring the physico-chemical properties of the polyester resins to be laminated, the method for assessing the characteristic features of the polyester laminate paper and the method for producing the polyester resins.

Method for Measuring the Physico-Chemical Properties of the Polyester Resins

(1) Thermal Properties

A sample of about 10 mg was scraped off from each of the polyester resins and was then sealed in an alumni pan in nitrogen atmosphere. Then, the temperature of the sample was elevated or lowered at a speed of ±20° C./min within a range of 30 to 300° C., to measure the melting point (Tm in ° C.) and crystallization temperature under temperature decrease (Tc in ° C.) of the polyester resins, using DSC (differential scanning calorimeter of ‘Type DSC220U’) manufactured by Seiko Instrument Co., Ltd.

(2) Intrinsic Viscosity

After the polyester resins were dried in hot air at 120° C. for about 6 hours, the intrinsic viscosity was measured in a mixture solution of phenol and 1,1,2,2-tetrachloroethane (at a weight ratio of 1:1 and the solution temperature of 30° C.), using a viscometer of Ubbelohde type.

(3) Content of Ti Atom

The concentration of the titanium metal in the raw material polyesters was measured in weight ratio by induced coupled plasma (ICP).

(4) Melt Tension and Melt Viscosity

After the raw material polyesters were dried at 120° C. for about 6 hours, the melt tension (mN) was measured at a cylinder temperature of 250° C. with a capillograph manufactured by Toyo Seiki Seisaku-Sho, Ltd. The take-off speed was 20 m/min, while the capillary used had a diameter and a length of 0.5 mm and 5 mm, respectively. The piston speed was 5 mm/min. After 10 g of the pellet was charged in the cylinder, the pellet was melted over 5 minutes. The average of melt tension in a period of 6 minutes to 7 minutes was used as the melt tension.

Meanwhile, the melt viscosity (Pa·S) of the raw material polyesters similarly dried was measured with a capillograph manufactured by Toyo Seiki Seisaku-Sho, Ltd. at a capillary temperature of 250° C. The take-off speed was 20 m/min, while the capillary used was with a diameter and a length of 1.0 mm and 30 mm, respectively. After 20 g of the pellet was charged in the cylinder, the pellet was melted over 3 minutes. The melt viscosity at a shear velocity of 91.2 sec⁻¹ was used.

(5) ΔIV Value

10 g of a raw material polyester (PBT pellet) and 25 ml of HFIP (hexafluoroisopropanol) were charged and agitated in a 200-ml Erlenmeyer flask. Then, only the HFIP solution was transferred into a 100-ml round-bottom flask, to separate the PBT pellet residue. After HFIP was distilled off from the HFIP solution, the round-bottom flask was dried at 100° C. under reduced pressure for 24 hours for additional removal of the solvent, to obtain the PBT pellet surface part (S) (3% by weight of the whole pellet) of 0.3 g. Subsequently, 25 ml of HFIP was added to the PBT pellet residue for agitation and dissolution, until the PBT pellet residue amounted to 0.8 g. The PBT pellet residue was recovered and dried at 100° C. under reduced pressure for 24 hours, to obtain the PBT pellet center part (C) at 0.5 g (5% by weight of the whole pellet). The intrinsic viscosities [η] (dl/g) of the resulting pellet surface part (S) and the center part (C) were individually measured in a mixture solution of phenol/1,1,2,2-tetrachloroethane at 50/50 (in weight ratio) at 30° C., using a viscometer of Ubbelohde type, to determine the difference ΔIV in the viscosities (=|IV(S)−IV(C)|).

Method for Assessing the Characteristic Features of Polyester Laminate Paper

(1) Thickness of Laminate Layer

Laminate paper was cut at three positions, namely at both the ends along width direction and at the center. The cross sections were enlarged at ×1,000 magnification and photographed, using a scanning electron microscope (manufactured by Hitachi Co., Ltd.; type S-2500). The polybutylene terephthalate resin composition in a thin film on the enlarged photographs was measured using a square of JIS First Grade. The average of the measurements at the three positions was calculated as the thickness (μm) of the laminate layer.

(2) Assessment of Extrusion Properties

Defining the die width value as W(A), the average of the PBT width in lamination on paper as measured at 10 positions at an interval of 1 m along the extrusion direction as W(B) and the sum of the length of a part with a film thickness above 18 microns around both the ends along the direction of PBT width as W(C), the neck-in level (%), the trimming level (%) and the take-off width level (%) were calculated according to the following formulas. Furthermore, the laminate velocities in Tables 1 and 2 mean the largest line speed enabling stable extrusion.
Neck-in level (%)={[W(A)−W(B)]/W(A)}×100
Trimming level (%)=[W(C)/W(B)]×100
Take-off width level (%)={[W(B)−W(C)]/W(A)}×100

When the extrusion lamination velocity was above 140 m/min, the extrusion properties were marked with ⊚; when the extrusion lamination velocity was at 130 to 140 m/min, the extrusion properties were marked with ◯; and when the extrusion lamination velocity was less than 130 m/min, the extrusion properties were marked with x.

(3) Assessment of Adhesiveness

During the course of the extrusion lamination of the raw material polyesters on base paper, an aluminium foil piece of a 200-mm square was inserted in between the paper and the melt polyester vertically along the MD direction (extrusion direction), to obtain a laminate sample partially containing a part with no adhesion of the polyester to the paper. A rectangle of a width of 15 mm and a length of 150 mm was cut out from the laminate sample. The rectangle sample consisted of a closely adhering part of 75 mm and a non-adhering part of 75 mm. The polyester end and the paper end at the non-adhering part were individually held with the chucks of a tensile tester, and were stretched at a speed of 200 mm/min, to evaluate the adhesiveness of the polyester film to the paper. Additionally, the number of test samples was 10 (n=10).

⊚: The polyester film in all of the 10 test samples was failed ductilely at the test with a stretch tester. When the polyester end and the paper end were slowly stretched with hands, the laminate paper was broken.

Circle: The polyester film in all of the 10 test samples was failed ductilely at the test with a stretch tester. When the polyester end and the paper end were slowly stretched with hands, the peeling of the film from the paper was observed.

x: Peeling over 5 mm or more between the polyester film and the paper was observed in one or more of the test samples at the test with a stretch tester.

(4) Assessment of Container Processability

30 sheets of the polyester laminate paper were layered together in a heat press machine with a female die and a male die of No. 8 gather type for molding at 130° C. for 3 seconds. The processability was evaluated by the following standards. Furthermore, 10 samples were prepared under the same conditions (n=10) for the test, which was done by visual evaluation.

◯: No change of container appearance after molding.

x: Partial peeling was observed between the polyester film and the paper after molding.

(5) Assessment of Color

The color of the polyester laminate paper was observed visually and evaluated by the following standards.

⊚: Almost no change compared with the original whiteness of paperboard.

∘: Slightly yellowish change compared with the original whiteness of paperboard.

Δ: Large yellowish change compared with the original whiteness of paperboard.

(6) Releasability

The appearance of the laminate paper container obtained by the following method was visually observed and evaluated.

⊚: No release trace was observed on the paper container. The paper containers in stack were readily separated individually.

◯: Paper container involving peeling off when rubbed with hands.

Δ: Paper containers hardly separated from each other.

x: Release trace and pin hole were observed on paper container.

(7) Thermal Resistance

Commercially available frozen gratin (Shrimp Gratin under trade name; manufactured by Ajinomoto Corporation) was placed in the laminate paper container obtained by the following method, for cooking under heating in an oven range (manufactured by Mitsubishi Electric Home Appliances Co., Ltd.; Type RO-CS32) set at 200° C. for 20 minutes. The appearance of the paper container after cooking under heating was visually observed for evaluation.

◯: Paper container retaining the original shape.

x: Paper container with deformation such as peripheral warping.

### EXAMPLES

### Examples 1 Through 6 and Comparative Examples 1 through 5

(Method for Producing Polyester Resins)

The individual raw material polyesters used in the following Examples and Comparative Examples were produced by directly polymerizing terephthalic acid and 1,4-butanediol together by the routine method, using a titanium-series polymerization catalyst as the polymerization catalyst. The polyesters were polyesters comprising the butylene terephthalate recurring unit (polybutylene terephthalate: PBT). The individual polyesters had the physico-chemical properties shown in Tables 1 and 2. The PBTs of Examples 1 through 6 and Comparative Example 1 were produced by melt polymerization until the intrinsic viscosities of the resulting polyester resins had values given in Table 1. The PBTs of Comparative Examples 2 through 5 were produced by polymerizing by solid phase polymerization a polyester resin with a specific intrinsic viscosity as polymerized by melt polymerization. The individual production processes are described in detail hereinbelow.

### Example

Feeding both 1,4-butanediol and terephthalic acid at a ratio of 1.8 moles of 1,4-butanediol per one mole of terephthalic acid in a slurry preparation tank, mixing both the raw materials with an agitation apparatus to prepare a slurry, continuously feeding the slurry in an esterification tank adjusted to a temperature and a pressure of 230° C. and 78.7 kPa (590 mmHg), respectively, concurrently feeding tetra-n-butyl titanate (50 ppm in the PBT yield) continuously as a catalyst, and progressing the esterification under agitation with an agitation apparatus in a retention time of 3 hours, an oligomer at an esterification ratio of 97.5% was obtained.

The oligomer obtained by the esterification was continuously fed into a first polycondensation tank adjusted to a temperature of 250° C. and a pressure of 2.66 kPa (20 mmHg), for polycondensation under agitation with an agitation apparatus in a retention time of 2 hours, to obtain a prepolymer with an intrinsic viscosity of 0.250 dl/g. The prepolymer was continuously fed into a second polycondensation tank adjusted to a temperature of 250° C. and a pressure of 0.133 kPa (1 mmHg), for progressing the polycondensation furthermore under agitation with an agitation apparatus in a retention time of 3 hours, transferring the reaction mixture into a polymer extractor die, extruding the resulting polymer into a shape of cylinder from the die, cooling the polymer in a cool water at 20° C. for 0.9 second, and cutting the polymer using a cutter to obtain polybutylene terephthalate pellets (PBT pellets). 100 pellets were taken out from the resulting pellets for weighing (the weight was defined as pellet weight). The weight was 2.5 g.

### Example 2

The same procedures as in Example 1 were carried out except for the retention time in the second polycondensation tank, which was 3.6 hours. PBT pellets at a pellet weight of 2.6 g (per 100 pellets) was obtained.

### Example 3

The same procedures as in Example 1 were carried out except for the retention time in the second polycondensation tank, which was 1.6 hours. PBT pellets at a pellet weight of 2.5 g (per 100 pellets) was obtained.

### Example 4

The same procedures as in Example 1 were carried out except for the use of 90 ppm of a titanium-series polymerization catalyst and the retention time in the second polycondensation tank, which was 3.9 hours. PBT pellets at a pellet weight of 2.5 g (per 100 pellets) was obtained.

### Example 5

The same procedures as in Example 1 were carried out except for the use of 180 ppm of a titanium-series polymerization catalyst. PBT pellets at a pellet weight of 2.4 g (per 100 pellets) was obtained.

### Example 6

Pellets with an intrinsic viscosity [η]=0.85 and a pellet weight of 2.4 g (per 100 pellets) as prepared by direct polymerization using a titanium-series polymerization catalyst of 50 ppm was treated by a solid phase polymerization in nitrogen atmosphere at 170° C. for 2 hours, to obtain PBT pellets with an intrinsic viscosity [η]=0.90.

### Comparative Example 1

The same procedures as in Example 1 were carried out except for the retention time in the second polycondensation tank, which was 2 hours. PBT pellets at a pellet weight of 2.4 g (per 100 pellets) was obtained.

### Comparative Example 2

Pellets with an intrinsic viscosity [η]=0.70 and a pellet weight of 2.4 g (per 100 pellets) as prepared by direct polymerization using a titanium-series polymerization catalyst of 50 ppm was treated by a solid phase polymerization in nitrogen atmosphere at 200° C. for 8 hours, to obtain PBT pellets with an intrinsic viscosity [η]=1.34.

### Comparative Example 3

Pellets with an intrinsic viscosity [α]=0.70 and a pellet weight of 2.4 g (per 100 pellets) as prepared by direct polymerization using a titanium-series polymerization catalyst of 50 ppm was treated by a solid phase polymerization in nitrogen atmosphere at 200° C. for 10 hours, to obtain PBT pellets with an intrinsic viscosity [η]=1.64.

### Comparative Example 4

Pellets with an intrinsic viscosity [η]=0.70 and a pellet weight of 2.4 g (per 100 pellets) as prepared by direct polymerization using a titanium-series polymerization catalyst of 50 ppm was treated by a solid phase polymerization in nitrogen atmosphere at 200° C. for 6 hours, to obtain PBT pellets with an intrinsic viscosity [η]=1.13.

### Comparative Example 5

Pellets with an intrinsic viscosity [η]=0.85 and a pellet weight of 2.5 g (per 100 pellets) as prepared by direct polymerization using a titanium-series polymerization catalyst of 50 ppm was treated by a solid phase polymerization in nitrogen atmosphere at 200° C. for 4 hours, to obtain PBT pellets with an intrinsic viscosity [η]=1.03.

As to the dimension of the pellets obtained in Examples 1 through 6 and Comparative Examples 1 through 5, the short diameter and long diameter of the cross section along the longitudinal direction were 2.61 to 2.75 mm on average; the average length along the longitudinal direction was 3.00 to 3.11 mm in Examples 1 through 6 or was 4.50 to 4.58 mm in Comparative Examples 1 through 5.

(Method for Producing Laminate Paper and Paper Container)

The pellets from the individual raw material PBTs shown below in Tables 1 and 2 were dried in a hot air dryer, charged in the hopper of a 90-mm single screw extruder mounted on a T die with a lip width of 2000 mm and a lip gap of 0.5 mm, for extrusion lamination at the resin temperature of 290° C., the screw rotation number of 16 rpm and the speeds shown in Tables 1 and 2 to a PBT thickness of 15 microns on white paper. The white paper herein used was a paper with the levelness degree of 30 seconds and 35 g/m².

In Comparative Example 1, the winding was so severe that the line speed was set at 100 m/min. Additionally for lamination, the chill roll was controlled to 30° C., while the interval between the chill roll and the lip was 100 mm. A gather container was prepared from each of the resulting laminate papers, using a thermal press molding machine at 130° C. Then, various evaluations were done. The results are shown in Tables 1 and 2.

TABLE 1

| Items | | Ex. 1 | Ex. 2 | Ex. 3 | Ex. 4 | Ex. 5 | Ex. 6 |
|---|---|---|---|---|---|---|---|
| PBT | melt tension | 0.98 | 1.53 | 0.61 | 2.32 | 1.45 | 0.60 |
| | (mN) | | | | | | |
| | intrinsic | 1.10 | 1.26 | 0.96 | 1.35 | 1.24 | 0.90 |
| | viscosity [η] | | | | | | |
| | content of Ti | 50 | 50 | 50 | 90 | 180 | 50 |
| | atom (ppm) | | | | | | |
| | ΔIV (dl/g) | <0.01 | <0.01 | <0.01 | <0.01 | <0.01 | 0.08 |
| | Tm/Tc (° C.) | 224/176 | 224/176 | 224/176 | 224/176 | 224/176 | 224/176 |
| Assessment | neck-in level | 8.0 | 8.8 | 9.2 | 9.8 | 9.8 | 9.2 |
| of Extrusion | (%) | | | | | | |
| properties | trimming level | 8.9 | 9.0 | 9.5 | 9.4 | 9.4 | 9.6 |
| | (%) | | | | | | |
| | take-off width | 83.8 | 83.0 | 82.1 | 81.7 | 81.7 | 83.2 |
| | level (%) | | | | | | |
| | lamination | 160 | 140 | 145 | 135 | 135 | 140 |
| | speed (m/min) | | | | | | |
| Assessment | adhesion of | ⊚ | ◯ | ⊚ | ◯ | ◯ | ◯ |
| of laminate | PBT to paper | | | | | | |
| | extrusion | ⊚ | ◯ | ⊚ | ◯ | ◯ | ◯ |
| | properties | | | | | | |
| | container | ◯ | ◯ | ◯ | ◯ | ◯ | ◯ |
| | processability | | | | | | |
| | color change | ⊚ | ⊚ | ⊚ | ◯ | Δ | ⊚ |

TABLE 2

| Items | | Com. Ex. 1 | Com. Ex. 2 | Com. Ex. 3 | Com. Ex. 4 | Com. Ex. 5 |
|---|---|---|---|---|---|---|
| PBT | melt tension | 0.40 | 3.00 | 5.50 | 2.28 | 0.93 |
| | (mN) | | | | | |
| | intrinsic | 0.85 | 1.34 | 1.64 | 1.13 | 1.03 |
| | viscosity [η] | | | | | |
| | content of Ti | 50 | 50 | 50 | 50 | 50 |
| | atom (ppm) | | | | | |
| | ΔIV (dl/g) | <0.01 | 0.27 | 0.30 | 0.21 | 0.15 |
| | Tm/Tc (° C.) | 224/176 | 224/176 | 224/176 | 224/176 | 224/176 |
| Assessment | neck-in level | 35.2 | 8.2 | 7.9 | 7.8 | 8.1 |
| of Extrusion | (%) | | | | | |
| properties | trimming level | 26.8 | 9.1 | 8.5 | 9.2 | 9.4 |
| | (%) | | | | | |
| | take-off width | 47.4 | 83.4 | 84.3 | 83.7 | 83.3 |
| | level (%) | | | | | |
| | lamination | 100 | 130 | 120 | 130 | 135 |
| | speed (m/min) | | | | | |
| Assessment | adhesion of | ◯ | X | X | X | X |
| of laminate | PBT to paper | | | | | |
| | extrusion | X | ◯ | X | ◯ | ◯ |
| | properties | | | | | |
| | container | X | X | X | ◯ | ◯ |
| | processability | | | | | |
| | color change | ⊚ | ◯ | ◯ | ◯ | ◯ |

In Comparative Examples 2 through 5, film thickness had a variation because of the increase of the load on the extruder screw, leading to a pressure variation during the extrusion lamination of the PBT pellets on the paper. Additionally when the discharge amount was elevated, non-melted matters were generated on the laminate paper.

From the results shown in Tables 1 and 2, the following can be understood.

(1) Examples 1 through 6 in Table 1 show that the use of resins satisfying all the conditions of the melt tension and intrinsic viscosity difference ΔIV in accordance with the invention as the polyester resin (A) involved low-level neck-in phenomenon during extrusion, a larger trim width of the laminate paper per T die width, and high-speed lamination with excellent extrusion properties. Further, adhesive properties at a practical level were attained, involving greater container processability with overall good performance.

Comparing Examples 1 through 4 with Example 5, less color change occurred on the paper in case of the content of titanium atom being 50 ppm or 90 ppm, compared with the case of being 180 ppm.

(2) Comparative Example 1 in Table 2 shows that the use of the polyester resin (A) with a melt viscosity less than 0.5 mN involved high-level neck-in phenomenon during extrusion, a smaller trim width of the laminate paper per T die width, difficulty in high-speed lamination and non-practical extrusion properties and further involving poor container processability.

(3) Comparative Examples 2 through 5 show in Table 2 that the use of the polyester resin (A) with an intrinsic viscosity difference ΔIV exceeding 0.1 involved poor adhesion of PBT to paper.

(4) Comparative Examples 2 and 3 show in Table 2 that the adhesion of PBT to paper was poor when the melt tension exceeded 2.5 mN, involving poor extrusion properties and poor container processability.

### Examples 7 Through 10

(Method for Producing Polyester Resin)

The same procedures as in Example 1 were carried out except for the retention time in the second polycondensation tank, which was 2.5 to 5.5 hours, to obtain PBT pellets with an intrinsic viscosity [η]=0.85 to 1.44. The resulting polyester resins had the physico-chemical properties shown in Table 3.

As to the dimension of the pellets obtained in Examples 7 through 10, the short diameter and long diameter of the cross section along the longitudinal direction were 2.61 to 2.74 mm on average; the average length along the longitudinal direction was 2.97 to 3.04 mm.

(Method for Producing Laminate Paper and Paper Container)

The pellets from the individual raw material PBTs shown below in Table 3 were dried in a hot air dryer at 120° C. for 6 hours. The PBT resin (A) was charged in the hopper of a 60-mm single screw extruder, while the PBT resin (B) was charged in the hopper of a 120-mm single screw extruder. The individually melted and kneaded resins (A) and (B) encountered each other through a tube in a layering T die of feed block type (lip width of 1500 mm, air gap of 70 mm and lip gap of 1.0 mm), where the melt layered film was then continuously co-extruded at the temperature of the individual resins at 290° C. onto a paper. The co-extruded layered film was cooled and wound under a pressure together with paper, using a chill roll controlled to 30° C., to produce a laminate paper of a thickness shown in Table 3. The paper herein used was a paper with a levelness degree of 30 seconds and 35 g/m². A box container was prepared from each of the resulting laminate papers, using a thermal press molding machine at 130° C., for various evaluations. The results are shown in Table 3.

TABLE 3

| Items | | Ex. 7 | Ex. 8 | Ex. 9 | Ex. 10 |
|---|---|---|---|---|---|
| PBT resin (B) | melt tension (mN) | 1.60 | 1.20 | 5.50 | 1.10 |
| | intrinsic viscosity [η] | 1.26 | 1.21 | 1.44 | 1.11 |
| | Tm/Tc (° C.) | 223/176 | 223/176 | 223/176 | 224/176 |
| | content of Ti atom (ppm) | 50 | 50 | 50 | 50 |
| | layer (B) thickness (μm) | 12 | 12 | 12 | 12 |
| PBT resin (A) | melt tension (mN) | 0.55 | 0.55 | 0.55 | 0.55 |
| | ΔIV (dl/g) | <0.01 | <0.01 | <0.01 | <0.01 |
| | melt viscosity (Pa · S) | 300 | 300 | 300 | 300 |
| | intrinsic viscosity [η] | 0.90 | 0.90 | 0.90 | 0.90 |
| | Tm/Tc (° C.) | 224/177 | 224/177 | 224/177 | 224/177 |
| | content of Ti atom (ppm) | 50 | 50 | 50 | 50 |
| | layer (A) thickness (μm) | 3 | 3 | 3 | 3 |
| Conditions for | laminate layer thickness (μm) | 15 | 15 | 15 | 15 |
| extrusion | d(B)/d(A) | 4 | 4 | 4 | 4 |
| | extrusion lamination speed (m/min) | 200 | 195 | 180 | 170 |
| Assessment | Extrusion properties | ⊚ | ⊚ | ◯ | ◯ |
| | Adhesiveness | ⊚ | ⊚ | ⊚ | ⊚ |
| | container processability | ◯ | ◯ | ◯ | ◯ |
| | color change | ⊚ | ⊚ | ◯ | ⊚ |

Examples 7 through 10 in Table 3 show that a laminate paper with all of excellent extrusion properties, adhesiveness and container processability can be obtained, when the PBT (A) with a melt viscosity of 500 Pa·s or less and the PBT (B) with a melt tension of 1.0 or more are laminated together to a film thickness ratio d(B)/d(A) within a range of 0.5 to 50.

### Examples 11 Through 14

### Examples of Blending Release Agent

(Methods for Producing Laminate Paper and Paper Container)

The PBT resin obtained by the same method as in Example 1 was dried in a hot air dryer set at 120° C. for 6 hours, into which a release agent at an amount described below in Table 4 was blended. The resulting mixture was charged in the hopper of a twin-screw extruder (manufactured by Japan Steel Works, Ltd.; Type TEX30HCT; L/D=30), for melt kneading under conditions of a screw rotation number of 200 rpm, a cylinder temperature of 280° C., and a discharge amount of 15 kg/hour to prepare pellets. The pellet was dried in a hot air dryer set at a temperature of 120° C. for 6 hours, charged in the hopper of a 65-mm single screw extruder (manufactured by Musashino Kikai; L/D=29), for melting under conditions of a screw rotation number of 16 rpm, and a cylinder temperature of 280° C., to extrude the melt mixture from a T die (die width of 850 mm and a lip gap of 0.6 mm) into a film to a thickness of the polybutylene terephthalate resin composition being 20 μm. The PBT resin composition in a film continuously extruded and non-bleached craft paper in a roll form continuously wound (manufactured by Oji Paper Co., Ltd.; OK under trade name, which is a non-bleached craft with a weight of 50 g/m² and a width of 600 mm) were inserted in between a chill roll adjusted to a temperature of 30° C. (diameter of 650 mm and a face length of 700 mm) and a press roll (made of hard rubber; diameter of 400 mm and a face length of 700 mm) arranged at a 70-mm air gap from the T die lip, for taking off at a take-off speed of 150 m/min. Then, the laminate paper was cooled around ambient temperature, to obtain a PBT laminate paper wound in a roll form.

The PBT laminate paper obtained by the method described above was cut into a circular plate piece of a diameter of 100 mm. 15 sheets of such circular plate were overlaid together, and molded with a molding machine arranged with a male die and a female die of No. 8 paper dish type at a molding temperature of 130° C., a pressure of 20 MPa, and a molding cycle of 5 seconds. The resulting PBT laminate paper container was evaluated concerning various characteristic properties by the methods described above. The results are shown in Table 4.

The release agent d1 in Table 4 was paraffin wax (manufactured by Nippon Seiro Co., Ltd.; trade name of 155 Wax), while the release agent d2 in Table 4 was monoglyceride (manufactured by Riken Vitamin Co., Ltd.; Rikemar S100A under trade name).

TABLE 4

| Items | | Ex. 11 | Ex. 12 | Ex. 13 | Ex. 14 |
|---|---|---|---|---|---|
| PBT | content in resin | 99.7 | 98.8 | 98.0 | 98.8 |
| | composition | | | | |
| | (% by weight) | | | | |
| | intrinsic viscosity | 1.10 | 1.10 | 1.10 | 1.10 |
| | [η] | | | | |
| | melt tension (mN) | 1.19 | 1.19 | 1.19 | 1.19 |
| | ΔIV (dl/g) | <0.01 | <0.01 | <0.01 | <0.01 |
| | Tm/Tc(°) | 224/175 | 224/175 | 224/175 | 224/175 |
| Release | content in resin | 0.30 | 1.20 | 1.20 | 1.20 |
| agent | composition | | | | |
| | (% by weight) | | | | |
| | type | d1 | d1 | d1 | d2 |
| Laminate | adhesion of PBT to | ◯ | ◯ | ◯ | ◯ |
| assessment | paper | | | | |
| | extrusion | ◯ | ◯ | ◯ | ◯ |
| | properties | | | | |
| | releasability | ◯ | ⊚ | ⊚ | ◯ |

Table 4 shows that the extrusion properties in producing PBT laminate paper were great and the releasability and adhesiveness of the thermally molded PBT laminate paper containers were also great, when the amounts of the release agents blended were within a range of 0.01 to 5.0% by weight.

### Examples 11 Through 14

### Example of Blending Lamellar Silicate Salts

(Methods for Producing Laminate Paper and Paper Container)

By the same procedures as in Example 11 except for the blending of lamellar silicate salts at amounts shown below in Table 5 instead of a release agent, PBT laminate papers and laminate paper containers were molded. The evaluation results thereof are shown in Table 5.

In Table 5, herein, the lamellar silicate salt e1 was montmorillonite (manufactured by Kunimine Industry; Kunipia F under trade name), while the lamellar silicate salt e2 was dimethyldioctadecyl ammonium-modified synthetic fluorine mica (manufactured by Corp Chemical Co., Ltd.; ME100 under trade name).

TABLE 5

| Items | | Ex. 15 | Ex. 16 | Ex. 17 | Ex. 18 |
|---|---|---|---|---|---|
| PBT | content in resin | 98.0 | 95.0 | 99.0 | 98.0 |
| | composition | | | | |
| | (% by weight) | | | | |
| | intrinsic viscosity | 1.10 | 1.10 | 1.10 | 1.10 |
| | [η] | | | | |
| | melt tension (mN) | 1.19 | 1.19 | 1.19 | 1.19 |
| | ΔIV (dl/g) | <0.01 | <0.01 | <0.01 | <0.01 |
| | Tm/Tc(°) | 224/175 | 224/175 | 224/175 | 224/175 |
| Lamellar | content in resin | 2.0 | 5.0 | 1.0 | 2.0 |
| silicate salt | composition | | | | |
| | (% by weight) | | | | |
| | type | e1 | e1 | e1 | e2 |
| Laminate | adhesion of PBT to | ◯ | ◯ | ◯ | ◯ |
| assessment | paper | | | | |
| | extrusion | ◯ | ◯ | ◯ | ◯ |
| | properties | | | | |
| | releasability | ◯ | ◯ | ◯ | ◯ |
| | Thermal resistance | ◯ | ◯ | ◯ | ◯ |

Table 5 shows that the extrusion properties in producing PBT laminate paper were great and the releasability, adhesiveness and thermal resistance of the thermally molded PBT laminate paper containers were also great, when the amounts of the lamellar silicate salts blended were within a range of 0.1 to 20% by weight.

The invention has been described above in detail with specific embodiments. However, a person skilled in the art can understand that various modifications may be possible within the scope and spirit of the invention. The present application is based on Japanese Patent Application No. 2004-260446 filed on Sep. 8, 2004, Japanese Patent Application No. 2004-271299 filed on Sep. 17, 2004, Japanese Patent Application No. 2005-197272 filed on Jul. 6, 2005, and Japanese Patent Application No. 2005-197456 filed on Jul. 6, 2005, which are cited by reference in their entireties.

What is claimed is:

1. A polyester resin (A) in a pellet form for use in laminate paper, which contains a butylene terephthalate recurring unit as the main component and satisfies the following conditions (1) and (2):
(1) the melt tension thereof at 250° C. is 0.5 to 2.5 mN; and
(2) the difference (ΔIV) between the intrinsic viscosity of pellet surface part IV (S) and the intrinsic viscosity of pellet center part IV (C) is 0.1 or less.

2. The polyester resin (A) for use in laminate paper according to claim 1, wherein the melt tension thereof at 250° C. is 0.55 to 1.40 mN.

3. The polyester resin (A) for use in laminate paper according to claim 1, wherein the polyester resin contains titanium atom at 10 to 85 ppm (in weight ratio).

4. The polyester resin (A) for use in laminate paper according to claim 1, wherein the intrinsic viscosity is 0.8 to 1.3 dl/g.

5. A polyester laminate paper prepared by laminating a polyester resin (A) in a pellet form on at least one of the faces of a paper, wherein the polyester resin (A) contains a butylene terephthalate recurring unit as the main component and satisfies the following conditions (1) and (2):
(1) the melt tension thereof at 250° C. is 0.5 to 2.5 mN; and
(2) the difference (ΔIV) between the intrinsic viscosity of pellet surface part IV (S) and the intrinsic viscosity of pellet center part IV (C) is 0.1 or less.

6. The polyester laminate paper according to claim 5, wherein the melt tension thereof at 250° C. is 0.55 to 1.40 mN.

7. The polyester laminate paper according to claim 5, wherein the polyester resin (A) contains titanium atom at 10 to 85 ppm (in weight ratio).

8. The polyester laminate paper according to claim 5, wherein the intrinsic viscosity of the resin (A) is 0.8 to 1.3 dl/g.

9. The polyester laminate paper according to claim 5, which is prepared by laminating a polyester resin composition prepared by blending a release agent in the resin (A) to 0.001 to 5.0% by weight on at least one of the faces of a paper.

10. The polyester laminate paper according to claim 5, wherein the paper has a polyester resin (B) laminated on a resin (A), the resin (A) is a resin with a melt viscosity of 500 Pa·S or less at 250° C. and a shear velocity of 91.2 sec⁻¹, and the resin (B) is a resin with a melt tension of 1.0 or more at 250° C.

11. The polyester laminate paper according to claim 10, wherein the film thickness ratio d(resin B)/d(resin A) after the lamination of the resin (B) on the resin (A) is 0.5 to 50.

12. The polyester laminate paper according to claim 5, wherein the levelness degree (by a measurement method according to JIS P8119) of the paper is 10 seconds or more.

13. A method for producing a polyester laminate paper comprising extruding and laminating a polyester resin (A) in a pellet form on at least one of the faces of a paper, wherein the polyester resin (A) contains a butylene terephthalate recurring unit as the main component and satisfies the following conditions (1) and (2):
(1) the melt tension thereof at 250° C. is 0.5 to 2.5 mN; and
(2) the difference (ΔIV) between the intrinsic viscosity of pellet surface part IV (S) and the intrinsic viscosity of pellet center part IV (C) is 0.1 or less.

14. The method for producing a polyester laminate paper according to claim 13, wherein the melt tension of the resin (A) at 250° C. is 0.55 to 1.40 mN.

15. The method for producing a polyester laminate paper according to claim 13, wherein the polyester resin (A) contains titanium atom at 10 to 85 ppm (in weight ratio).

16. The method for producing a polyester laminate paper according to claim 13, wherein the intrinsic viscosity of the resin (A) is 0.8 to 1.3 dl/g.

17. The method for producing a polyester laminate paper according to claim 13, comprising laminating a polyester resin (B) on a polyester resin (A) via co-extrusion, wherein the resin (A) is a resin with a melt viscosity of 500 Pa·S or less at 250° C. and a shear velocity of 91.2 sec⁻¹, the resin (B) is a resin with a melt tension of 1.0 or more at 250° C.

18. The method for producing a polyester laminate paper according to claim 17, wherein the resin (A) and the resin (B) are laminated together to a film thickness ratio d(resin B)/d(resin A) of 0.5 to 50.

19. A polyester laminate paper container prepared by molding a polyester laminate paper according to claim 5.

20. The polyester laminate paper container according to claim 19, wherein the container is a container for packaging food products.

21. A polyester resin composition for use in laminate paper, which is prepared by blending a release agent in a polyester resin containing a butylene terephthalate recurring unit as the main component at 0.001 to 5.0% by weight.

22. The polyester resin composition for use in laminate paper according to claim 21, wherein the release agent is at least one selected from the group consisting of paraffin wax, polyethylene wax, higher fatty acid esters and higher fatty acid metal salts.

23. A polyester laminate paper prepared by laminating a polyester resin composition for use in laminate paper according to claim 22 on at least one of the faces of a paper.

24. A polyester laminate paper container prepared by molding a polyester laminate paper according to claim 23.
